(19) United States
(12) Patent Application Publication
(10) Pub. No.: US 2002/0067234 A1
(43) Pub. Date: Jun. 6, 2002

(54) Compact surface-mountable inductors

(76) Inventor: Samuel Kung, Fullerton, CA (US)

Correspondence Address: Eric K. Satermo, Registered Patent Agent, P. O. Box 19099, Irvine, CA, 92623-9099, US

(21) Appl. No.: 09/728,456

(22) Filed: Dec. 1, 2000

(51) Int. Cl. H01F 27/29

(52) U.S. Cl. 336/192

(57) ABSTRACT

An inductive device mounted to the surface of a circuit board forms an inductor in an electrical circuit and provides a high level of inductance while occupying a relatively small amount of space. An inductive device forms an inductor when mounted on a circuit board including a plurality of pads. The inductive device includes a core and a conductor. The conductor extends partially around at least a portion of the core and including a plurality of contact surfaces. The conductor forms a coil around at least a portion of the core to form an inductor when the contact surfaces are mated with the pads of the circuit board. A portion of the conductor may extend through the core. The core may include a first plate and a second plate, with a portion of the conductor extending between the plates. Alternatively, one of the plates may include a groove for receiving the conductor when the plates are attached together. The conductor may include a pair of C shaped elements that slide over the core.

### BACKGROUND OF THE INVENTION

1. Field of the Invention

The present invention relates to electrical components and circuits and, more particularly, to inductors, inductive components, and inductive circuits. The devices of the present invention are streamline in design and construction and may be configured in relatively small elements, thereby enabling application in circuits where minimal size and weight are of utmost importance, such as in portable electrical devices. In addition, the devices of the present invention are configured to provide suitable inductance for high-current applications, such as DC-DC conversion applications for high-speed processors which draw current of, e.g., 60 amps at speeds of 1 MHz.

2. Description of the Related Art

Virtually every single electrical device in existence has an electrical circuit. Along with resistors and capacitors, an inductor is a circuit element that a designer may incorporate into an electrical circuit. Both the inductor and the capacitor are capable of storing and delivering finite amounts of energy. Unlike ideal sources of power, capacitors and inductors can provide neither an unlimited amount of energy nor a finite average power over an infinite time interval. Capacitors and inductors (as well as resistors) are, therefore, classified as passive circuit elements. While capacitors store energy in an electric field, inductors store magnetic energy. Prior to describing physical inductors in detail, a brief sketch of the historical development of the magnetic field will be provided, which includes a cast of some of the most celebrated scientists of the past two hundred years.

In the early 1800s, the Danish scientist Hans Christian Oersted showed that a current-carrying conductor produced a magnetic field, or that compass needles were affected in the presence of a current-carrying conductor. In France, shortly thereafter, André Marie Ampère made measurements which demonstrated that this magnetic field was linearly related to the current in the conductor.

The next step in the historical development of the magnetic field occurred some twenty years later when the English experimentalist Michael Faraday and the American inventor Joseph Henry discovered almost simultaneously that a changing magnetic field could induce a voltage in a neighboring circuit. Faraday and Henry showed that this voltage was proportional to the time rate of change of the current which produced the magnetic field. The constant of proportionality now called inductance, symbolized by L, is therefore defined as:

v=L(di/dt) (1)

where the voltage v and the current i are both functions of time. The unit in which inductance is measured is the henry (H), and the equation above shows that the henry is a shorter expression of a volt-second per ampere.

The inductor whose inductance is defined by the equation above is a mathematical model; that is, such an inductor is an ideal element that is used to approximate the behavior of a real device. An actual physical inductor may be constructed by winding a length of wire into a coil. This serves effectively to increase the current which is causing the magnetic field and also to increase the “number” of neighboring circuits into which Faraday's voltage may be induced. The result of this twofold effect is that the inductance of a coil is approximately proportional to the square of the number of complete turns made by the conductor out of which it is formed.

An inductor, or “coil,” which has the form of a long helix of very small pitch is found to have an inductance of:

L=μN²A/x (2)

where A is the cross-sectional area, s is the axial length of the helix, N is the number of complete turns of wire, and μ is a constant of the material inside the helix, called the permeability. For free space (and very closely for air), μ=μ₀=4π×10⁻⁷ H/m. Magnetic energy is stored as long as current flows through the inductor, as shown by:

W=LI²÷2 (3)

where W is the magnetic energy injoules J (watt-seconds), L is the inductance, and I is the current.

It is unlikely that the renowned scientists who were collectively responsible for developing inductors would have foreseen the many important applications for the circuit element today. A number of these applications require inductors to store high levels of energy per unit volume of space that the inductor occupies. These applications also often require the inductors to operate at high levels of current, for example, greater than 15 amps.

Indeed, one of the applications for inductors is in the power management of high-speed processors, particularly in DC-DC conversion. As processor speeds increase, current demand increases. And electrical components associated with such processors need to operate at high current such as 60 amps. In order to store high levels of energy required for these applications, inductance needs to increase. However, as inductance is proportional to the number of turns N and the cross-sectional area A, as given by Equation 2 above, to increase inductance, the size of the inductor increases, which is undesirable.

One example of an application in which large size is undesirable is where circuit boards are stacked in a parallel-plane relationship. Typical distances between adjacent boards are on the order of 5 millimeters (mm). Many industry sectors see this distance going to 3 mm. While other electrical component have now been reduced in size to meet this demand, components required for power management, including inductors, have not yet met this requirement. Accordingly, power-management components are often the limiting factor in how small a particular electrical device may be.

In view of the foregoing, there remains a need in the art for an inductive device that is able to provide adequate levels of inductance while occupying a relatively small amount of space.

### SUMMARY OF THE INVENTION

The present invention overcomes the drawbacks associated with conventional inductors, inductive devices, and electrical circuits including inductors.

According to a preferred embodiment of the invention, an inductive device forms an inductor when mounted on a circuit board including a plurality of pads. The inductive device includes a core and a conductor. The conductor extends partially around at least a portion of the core and including a plurality of contact surfaces. The conductor forms a coil around at least a portion of the core to form an inductor when the contact surfaces are mated with the pads of the circuit board.

One of the many advantages of the invention is that a relatively high level of inductance can be provided in a relatively small amount of space that the inductive device occupies within an electronic device. For example, for each cubic millimeter of space that the inductive device occupies, at least about 2 nanoHenry of inductance may be provided. This high inductance per unit volume has many beneficial applications, including, for example, power supplies for high-speed microprocessors.

The inductive device may take on any number of preferred embodiments. For example, a portion of the conductor may extend through the core. To implement this preferred configuration, the core may include a first plate and a second plate, with a portion of the conductor extending between the plates. Alternatively, one of the plates may include a groove for receiving the conductor when the plates are attached together.

According to another preferred embodiment, the conductor is C shaped. Such a configuration allows for not only partial extension of the conductor around the core, but also fast, easy, and inexpensive fabrication of the inductive device.

In addition, the conductor may include a first element and a second element, with each of the elements extending partially around at least a portion of the core. Each of the elements may be C shaped as mentioned above. The elements form a complete coil when the inductive device is mounted to a circuit boards with a plurality of pads, also as mentioned above. In the plural element embodiment of the invention, the core may include a spacer for maintaining the elements in a spaced relationship.

According to another aspect of the invention, the core includes a first plate, a second plate, and a channel formed between the plates, and the conductor includes a first element and a second element each having a transverse portion and a pair of end clips. The transverse portion of each of the elements is received within the channel between the plates, and each of the end clips engages a respective opposing edge of one of the plates. Each of the end clips includes one of the contact surfaces for mating with respective pads of a circuit board.

One of the advantages of this embodiment is that each component of the inductive device, that is, the plates of the core and the elements of the conductor, may be prefabricated inexpensively and then machine assembled. Accordingly, the cost of producing the inductive device and, therefore, an inductor for an electric circuit is greatly reduced.

In this regard, according to another aspect of the invention, an electric circuit includes a plurality of pads disposed on a circuit board and an inductor. The inductor includes a core and a coil. The coil includes a conductor having a plurality of contact surfaces and extending partially around at least a portion of the core. The contact surfaces of the conductor mated with a corresponding number of pads on the circuit board to complete the coil around the core. The electric circuit of the invention may include a plurality of the inductors and an electric circuit element in communication with one or more of the inductors.

Preferred methodology of the invention streamlines the fabrication process of forming inductive devices by minimizing the number of steps. For example, after providing a core and a conductor, both of which may be prefabricated, the conductor is disposed over the core so that the conductor extends partially around the core. Depending upon the configuration of the conductor, for example, C shaped, the conductor may be slid over the core. In addition, the core may include a first plate and a second plate that are attached together with at least a portion of the conductor is positioned therebetween.

Other objects, features, and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIG. 1 is fragmentary exploded perspective view of an inductive device in combination with a circuit board of the present invention;

FIG. 2 is a cross-sectional view of an inductor of the present invention taken along line 2-2 of FIG. 1;

FIG. 3 a perspective view of an exemplary inductive device configured in accordance with the principles present invention, particularly illustrating the device from a top perspective;

FIG. 4 is a perspective view of the inductive device of FIG. 3, particularly illustrating the device from a bottom perspective;

FIG. 5 is an exploded view of the inductive device of FIG. 3;

FIG. 6 is a perspective view of a plate of a core of the inductor of FIG. 3, particularly showing an inner side of the plate;

FIG. 7 is a cross-sectional view of the inductive device taken along line 7-7 of FIG. 3;

FIG. 8 is a cross-sectional view of the inductive device taken along line 8-8 of FIG. 3;

FIG. 9 is a flow chart illustrating exemplary methodology for fabricating inductive devices in accordance with the present invention;

FIG. 10 is a schematic view of an exemplary circuit and circuit board according to the principles of the present invention, particularly illustrating a circuit board configured to form a two-turn coil inductor of the invention;

FIG. 11 is a schematic view of an alternative exemplary circuit and circuit board according to the principles of the present invention, particularly illustrating a circuit board configured to form a single-turn coil inductor of the invention; and

FIG. 12 is a schematic view of a DC-DC converter circuit of the present invention.

### DETAILED DESCRIPTION OF THE INVENTION

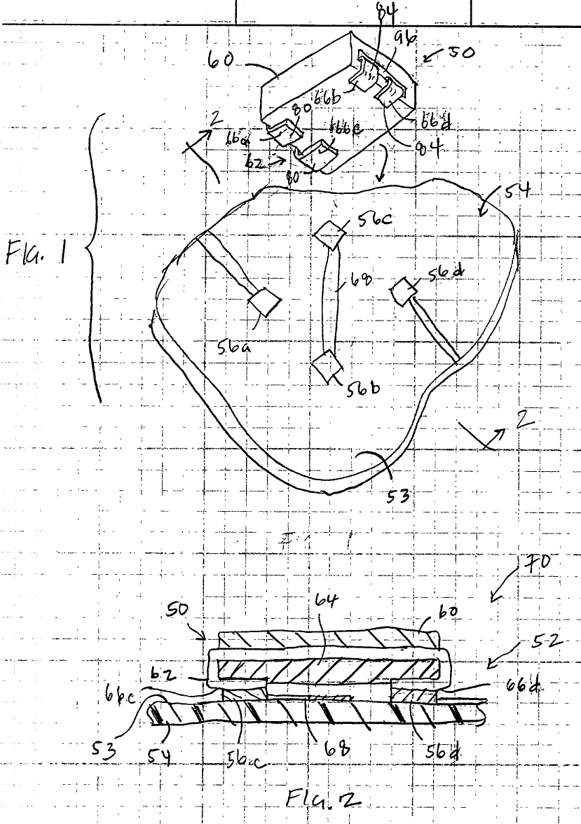

Referring more particularly to the drawings, an inductive device 50 is illustrated in accordance with a specific preferred embodiment in FIGS. 1 and 2 to exemplify the principles of the invention. Exemplary inductive device 50 is configured to form an inductor 52 when disposed on or mounted on a surface 53 of a circuit board 54 with two or more pads 56a, 56b, 56c, 56d. Inductive device 50 of the present invention generally includes a core 60 and a conductor 62. As shown in FIG. 2, exemplary conductor 62 extends partially around at least a portion of core 60, which portion is indicated by numeral 64.

As shown in FIG. 1, conductor 62 includes two or more contact surfaces 66a, 66b, 66c, 66d. Also shown in FIG. 1, exemplary circuit board 54 may include a conductive tie 68 connected between two pads, e.g., pads 56c and 56d. In conjunction with tie 68, exemplary conductor 62 forms a complete coil around portion 64 of core 60, thereby forming an inductor 70, when contact surfaces 66 are mated with pads 56 of circuit board 54 as shown in FIG. 2.

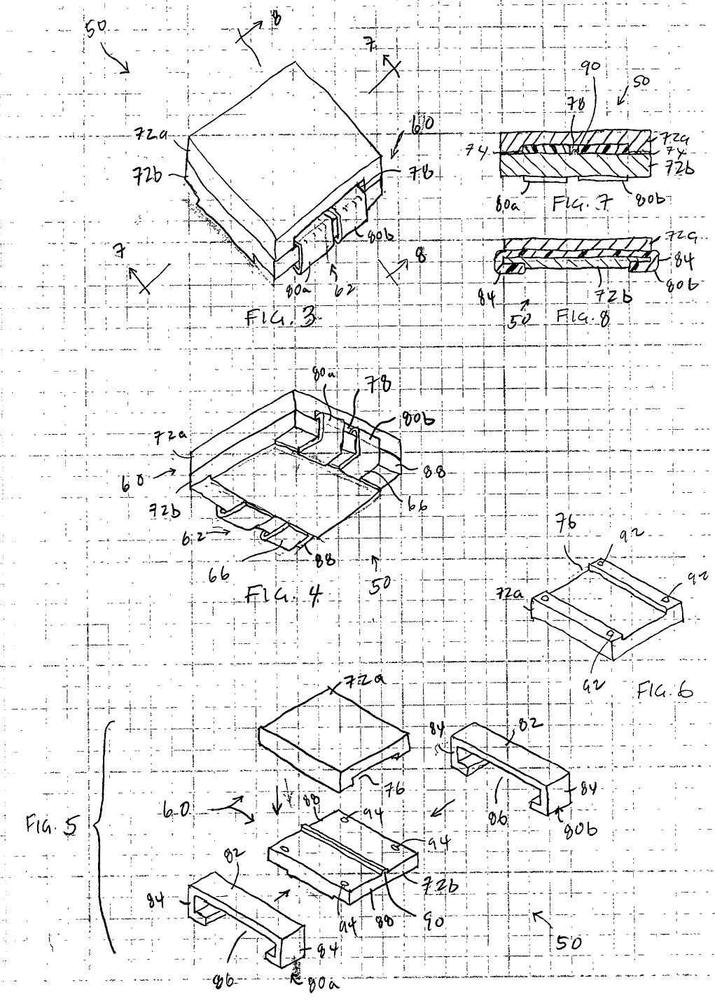

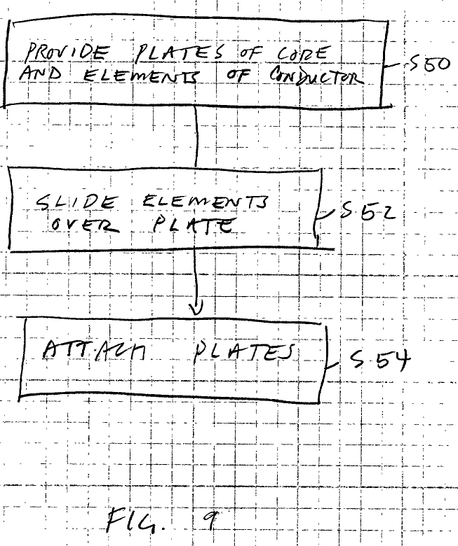

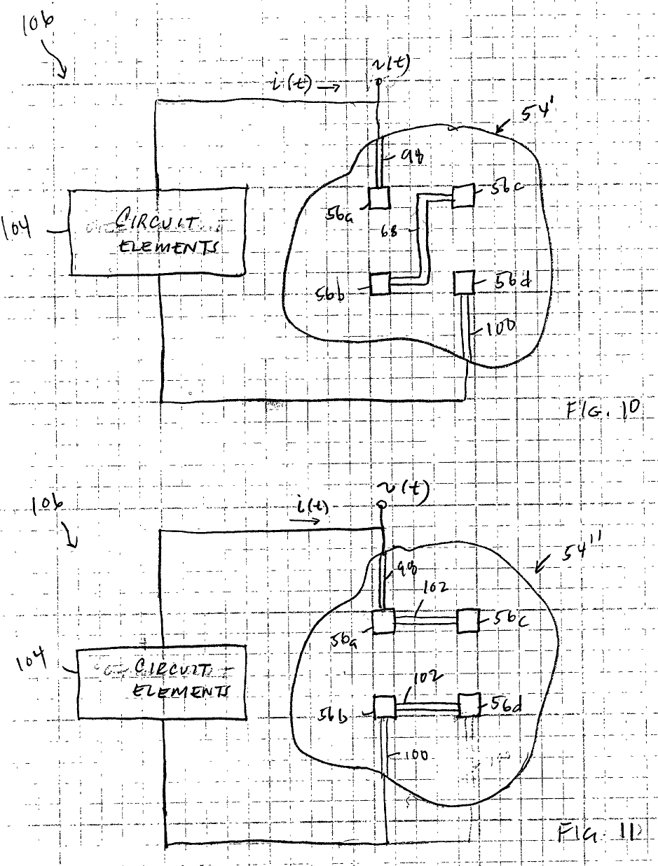

Prior to discussing the features of inductor 70, exemplary inductive device 50 will be described in detail. In this regard, reference is made to FIGS. 3, 4, 5, 6, 7, and 8 in which a preferred embodiment of inductive device 50 is shown. Exemplary core 60 may include a first plate 72a and a second plate 72b attached together so that at least a portion of conductor 62 is received therebetween. Plates 72 may be attached together by suitable means, such as adhesive 74 as shown in FIG. 7. To accommodate conductor 62, one of the plates of core 60, for example, first plate 74a, may include a groove 76 as shown in FIGS. 5 and 6. Accordingly, when plates 72 at attached, groove 76 defines a channel 78 through which conductor 62 is receivable as shown in FIGS. 3, 4, and 7.

With continued reference to FIGS. 3-8, exemplary conductor 62 may include a first element 80a and a second element 80b, with each element 80 defining an incomplete turn or loop. For example, each element 80 may be substantially C shaped as shown in FIG. 5. Accordingly, as mentioned above, each element 80 extends partially around at least a portion of core 60, for example, around a portion of second plate 72b.

More specifically, according to the preferred embodiment shown in FIG. 5, each element 80 of conductor 62 may have a transverse portion 82 and a pair of end clips 84 within which a slot 86 is defined. Each transverse portion 82 is configured to be received within channel 78 of core 60, with each end clip 84 engaging a respective opposing edge 88 of one of the plates, e.g., second plate 72b. Describing exemplary inductive device 50 in other terms, each element 80 is slidably receivable over second plate 72b, with respective portions of plate 72b being receivable within slots 86. As shown in FIG. 4, each end clip 84 may include a contact surface 66 as described above.

Describing further features of inductive device 50, as shown in FIGS. 5 and 7, second plate 72 may include a transverse spacer 90 to maintain elements 80 in spaced relationship. Also, each opposing edge 88 of second plate 72b may have a reduced thickness to facilitate fabrication. In addition, each plate 72 may include structure for facilitating the alignment of the plates during fabrication. For example, first plate 72a may include one or more projections 92 as shown in FIG. 6, and second plate 72b may include a corresponding number of complementary dimples 94 as shown in FIG. 5. Projections 92 and dimples 94 respectively mate during fabrication to align plates 72 and retain the plates in alignment.

In view of the foregoing, exemplary inductive device 50 may be fabricated in a streamlined and efficient process with a minimal number of steps. In this regards, with reference to FIG. 9, upon providing plates 72 of core 60 and elements 80 of conductor 62 (step S50), elements 80 may be slid onto respective opposing edges of one of the plates (step S52), e.g., second plate 72b. Thereafter, plates 72 may be attached together (step S54), e.g., with adhesive as described above. Overall, core 60 and conductor 62 may be prefabricated and then assembled by machine automation for highly efficient and productive manufacture of inductive device 50.

As shown in FIG. 1, rather than configuring core 60 in a pair of plates, exemplary core 60 may be comprised of a single piece of material with a channel 96 through which the conductor is receivable. In this embodiment, during fabrication, elements 80 of conductor 62 may be planar to allow insertion into channel 96, and then bent over to form end clips 84. According to another alternative embodiment of the present invention, exemplary conductor 62 includes three or more elements 80 (not shown).

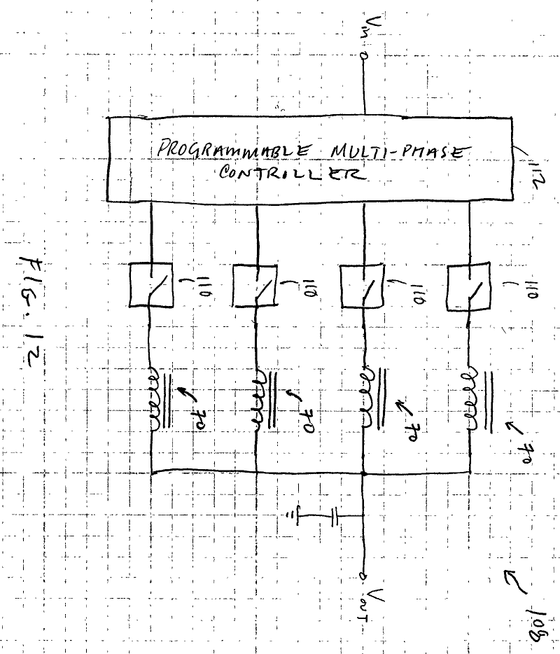

One of the advantages of the present invention is the versatility of inductive device 50. For example, in the preferred embodiments described above, inductive device 50 may be utilized to form an inductor with a coil having either one turn or two turns. Given an embodiment with two elements 80 comprising conductor 62 such as that shown in FIGS. 1 and 2, an inductor 70 having a coil with two turns may be formed with a circuit board 54′ such as that shown in FIG. 10.

Analogous to that described above, circuit board 54′ includes a plurality of pads 56 with conductive tie 68 connected between diagonally opposite pads, e.g., pads 56c and 56d. Accordingly, when inductive device 50 is mounted to circuit board 54′, contact surface 66a mates with pad 56a, contact surface 66b mates with pad 56b, contact surface 66c mates with pad 56c, and contact surface 66d mates with pad 56d. Inductive device 50 may be mounted to circuit board 54 with, for example, solder paste as known in the art. The path of current i then flows through lead 98, pad 56a, first element 80a, pad 56b, tie 68, pad 56c, second element 80b, pad 56d, and lead 100. Therefore, a two-turn coil for formed with elements 80 and conductive tie 68.

For form an inductor with a single-turn coil, exemplary inductive device 50 may be mounted on a circuit board 54″ as shown in FIG. 11. Exemplary circuit board 54″ includes a plurality of pads 56 and a pair of ties 102. One tie 102 is connected between pads 56a and 56c, and the other tie 102 is connected between pads 56b and 56d. Accordingly, when inductive device 50 is mounted to circuit board 54″, elements 80 are shorted by ties 102 so that a single-turn coil is formed with elements 80 and ties 102.

In either embodiment, any number and type of circuit elements 104 may be configured with inductor 70 to form a circuit 106. A specific circuit 108 utilizing inductive devices 50 of the present invention is shown FIG. 12, which circuit is a DC-DC converter. Exemplary converter circuit 108 includes a plurality of inductors 70 each with a switch 110 connected in parallel with a programmable multi-phase controller 112. Such a circuit 108 could be used in a power supply for a high-power microprocessor.

A background discussion of DC-DC converters and exemplary circuits may be in The Electrical Engineering Handbook, Second Edition (CRC Press, 1997), at pages 777 to 779, the entire disclosure of which is incorporated herein by reference. Additional examples of DC-DC converter circuits may be found in the Electronic Circuits Manual by John Markus (McGraw-Hill Book Company, 1971) at pages 138 to 144, the entire disclosure of which is incorporated herein by reference.

As mentioned, inductor 70 is particularly suitable for high-current and high-speed applications. Typically, as current and frequency increase, inductance decreases. To provide sufficient inductance for such application, exemplary inductor 70 is able to provide, for example, 70 μH at 15 amps for a two-turn coil as shown in FIGS. 2 and 10, and 15 μH at 30 amps for a single-turn coil as shown in FIG. 11.

More generally, inductive device 50 may be described as provide a certain amount of inductance at a particular current per unit volume of space occupied by device 50. For example, according to one preferred commercial embodiment, if core 60 is made of iron and conductor 62 is made of copper, then at a current of, e.g., 15 amps, inductor 70 is above to provide an inductance of 2 nanoHenry (nH) for every 1 cubic millimeter (mm³) of space. According to another preferred commercial embodiment, exemplary inductive device 50 may have a length and a width of less than about 8 mm and a thickness of less than about 3 mm.

Those skilled in the art will understand that the preceding exemplary embodiments of the present invention provide the foundation for numerous alternatives and modifications thereto. These other modifications are also within the scope of the present invention. For example, the term “plate” is used herein to name each of the components of core 60. However, although “plate” infers a rectilinear element indicative to that shown in the preferred embodiments in the drawings, the plates may be configured in any desired shape or form, including curvilinear, hemispherical, circular, rounded, and so on. That is, the scope of the present invention is not limited by the geometry of the respective elements. Similarly, alternative conductors may be used to function with any variety of cores in accordance with the principles and teachings of the present invention. In this manner, a wide variety of inductive devices and inductors may be configured. Accordingly, the present invention is not limited to that precisely as shown and described in the present invention.

What is claimed is:

1. An inductive device for forming an inductor on a circuit board, the circuit board including a plurality of pads, the inductive device comprising:
a core; and
a conductor extending partially around at least a portion of the core and including a plurality of contact surfaces;
the conductor forming a coil around at least a portion of the core to form an inductor when the contact surfaces are mated with the pads of the circuit board.

2. An inductive device as claimed in claim 1 wherein a portion of the conductor extends through the core.

3. An inductive device as claimed in claim 1 wherein the core includes a first plate and a second plate;
a portion of the conductor extending between the plates of the core.

4. An inductive device as claimed in claim 3 wherein the plates of the core are adhered together.

5. An inductive device as claimed in claim 3 wherein one of the plates of the core includes a groove for receiving the conductor when the plates are attached together.

6. An inductive device as claimed in claim 1 wherein the conductor is C shaped.

7. An inductive device as claimed in claim 1 wherein the conductor includes a first element and a second element;
each of the elements extending partially around at least a portion of the core.

8. An inductive device as claimed in claim 7 wherein the core includes a spacer for maintaining the elements in a spaced relationship.

9. An inductive device as claimed in claim 1 wherein:
the core includes a first plate, a second plate, and a channel formed between the plates; and
the conductor includes a first element and a second element each having a transverse portion and a pair of end clips;
the transverse portion of each of the elements being received within the channel; and
each of the end clips engaging a respective opposing edge of one of the plates.

10. An inductive device as claimed in claim 1 wherein each of the end clips includes one of the contact surfaces.

11. In combination, a circuit board and an inductive device, the combination comprising:
a circuit board including a board and a plurality of pads disposed on the board; and
an inductive element including:
a core; and
a conductor extending partially around at least a portion of the core and including a plurality of contact surfaces;
the contact surfaces of the conductor being mated with the pads of the circuit board to form a coil around at least a portion of the core, thereby forming an inductor.

12. A combination as claimed in claim 11 wherein the circuit board includes a conductive tie disposed between two of the pads.

13. A combination as claimed in claim 12 wherein the conductive tie is configured so that the coil includes one turn.

14. A combination as claimed in claim 13 wherein the conductive tie is configured so that the coil includes a plurality of turns.

15. An electric circuit formed on a circuit board, the electric circuit comprising:
a plurality of pads disposed on the circuit board; and
an inductor including:
a core; and
a coil including a conductor extending partially around at least a portion of the core and including a plurality of contact surfaces;
the contact surfaces of the conductor being mated with a corresponding number of pads to complete the coil around at least a portion of the core.

16. An electric circuit as claimed in claim 15 further comprising a plurality of the inductors.

17. An electric circuit as claimed in claim 15 further comprising an electric circuit element in communication with the inductor.

18. A method for fabricating an inductive device, the method comprising:
providing a core;
providing a conductor; and
disposing the conductor over the core so that the conductor extends partially around the core.

19. A method as claimed in claim 18 wherein the core includes a first plate and a second plate, the method further comprising:
attaching the first plate to the second plate so that at least a portion of the conductor is positioned therebetween.

20. A method as claimed in claim 18 wherein the conductor includes a first C-shaped element and a second C-shaped element, wherein the disposing step comprises:
sliding each of the elements over the core so that the element extends partially around the core.
